(19) United States
(12) Patent Application Publication
(10) Pub. No.: US 2026/0338091 A1
(43) Pub. Date: Oct. 29, 2026

(54) A CENTRIFUGAL SEPARATOR FOR CLEANING GAS

(71) Applicant: Alfdex AB, LANDSKRONA (SE)

(72) Inventors: Mats-Örjan POGÉN, BILLEBERGA (SE); Thomas ANDERSSON AGINGER, SKÄRHOLMEN (SE)

(73) Assignee: Alfdex AB, LANDSKRONA (SE)

(21) Appl. No.: 19/109,925

(22) PCT Filed: Aug. 22, 2023
(86) PCT No.: PCT/EP2023/072978

§ 371 Date: Mar. 7, 2025

(30) Foreign Application Priority Data
Sep. 9, 2022 (EP) 22194816.9

(51) Int. Cl. F01M 13/04; B01D 45/14

(52) U.S. Cl. CPC F01M 13/04; B01D 45/14; F01M 2013/0422

(57) ABSTRACT

A centrifugal separator for cleaning gas containing contaminants. The centrifugal separator includes a stationary casing, enclosing a separation space through which a gas flow is permitted, a gas inlet extending through the stationary casing and permitting supply of the gas to be cleaned and a rotating member comprising a plurality of separation members arranged in said separation space and being arranged to rotate around an axis of rotation. The separator further includes a gas outlet configured to permit discharge of cleaned gas out from the stationary casing, a drainage outlet configured to permit discharge from the centrifugal separator of liquid contaminants that have been separated from the gas and a drive member for rotating the rotating member. The centrifugal separator further includes a mounting bracket configured for mounting the centrifugal separator onto an engine or an engine block and engaged with the outer surface of the stationary casing. The mounting bracket and the stationary casing are configured to allow permanently engaging the mounting bracket to the outer surface of the stationary casing in different angular positions around the axis of rotation.

### FIELD OF THE INVENTION

The present invention relates to the field of centrifugal separators for cleaning a gas containing liquid contaminants. In particular, the present invention relates to a separator for cleaning crankcase gases of a combustion engine from oil particles.

### BACKGROUND OF THE INVENTION

It is well known that a mixture of fluids having different densities may be separated from one another through use of a centrifugal separator. One specific use of such a separator is in the separation of oil from gas vented from a crankcase forming part of an internal combustion engine.

With regard to this specific use of separators, there can be a tendency for the high-pressure gas found in the combustion chambers of an internal combustion engine to leak past the associated piston rings and into the crankcase of the engine. This continuous leaking of gas into the crankcase can lead to an undesirable increase of pressure within the crankcase and, as a consequence, to a need to vent gas from the casing. Such gas vented from the crankcase typically carries a quantity of engine oil (as droplets or a fine mist), which is picked up from the reservoir of oil held in the crankcase.

In order to allow vented gas to be introduced into the inlet system without also introducing unwanted oil (particularly into a turbocharging system wherein the efficiency of the compressor can be adversely affected by the presence of oil), it is necessary to clean the vented gas (i.e. to remove the oil carried by the gas) prior to the gas being introduced into the inlet system. This cleaning process may be undertaken by a centrifugal separator, which is mounted on or adjacent the crankcase and which directs cleaned gas to the inlet system and directs separated oil back to the crankcase. An example of such a separator is disclosed e.g. in U.S. Pat. No. 8,657,908.

A centrifugal separator for cleaning crankcase gas is usually fastened to the engine or engine block. This usually requires a rather stiff design to minimize vibrations. As an example, the separator may be fastened to the engine or engine block via a metallic bracket that connects the lower part of the centrifugal separator to the engine or engine block.

Further, the space around the engine or engine block may be rather limited, and with prior art designs of fastening the separator, it may be difficult to adapt the position of the gas inlet and outlet to the actual available space around the engine. In other words, means that the flexibility when adapting the position of a centrifugal separator to an engine or engine block is rather limited.

Thus, there is a need in the art for an improved flexibility in the fastening of a centrifugal separator to an engine or engine block.

### SUMMARY OF THE INVENTION

It is an object of the invention to at least partly overcome one or more limitations of the prior art. In particular, it is an object to provide a centrifugal separator which facilitates an improved flexibility for adapting the centrifugal separator to different engine or engine blocks.

As a first aspect of the invention, there is provided a centrifugal separator for cleaning gas containing contaminants, said centrifugal separator comprising
a stationary casing, enclosing a separation space through which a gas flow is permitted and comprising a surrounding sidewall that surrounds the separation space,
a gas inlet extending through the stationary casing and permitting supply of the gas to be cleaned,
a rotating member comprising a plurality of separation members arranged in said separation space and being arranged to rotate around an axis (X) of rotation,
a gas outlet configured to permit discharge of cleaned gas out from the stationary casing,
a drainage outlet configured to permit discharge from the centrifugal separator of liquid contaminants that have been separated from the gas;
a drive member for rotating the rotating member;
wherein the centrifugal separator further comprises
a mounting bracket configured for mounting the centrifugal separator onto an engine or an engine block and engaged with the outer surface of the surrounding sidewall of the stationary casing,
and wherein the mounting bracket and the stationary casing are configured to allow permanently engaging the mounting bracket to the outer surface of the surrounding sidewall of the stationary casing in different angular positions around the axis (X) of rotation.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X). A “radially inner position” thus refers to a position closer to the rotational axis (X) compared to “a radially outer position”. A radial plane is a plane having its normal parallel to the axis of rotation (X). An axial plane is a plane having its normal perpendicular to the axis of rotation (X).

The contaminants in the gas may comprise liquid contaminants, such as oil, and soot.

Consequently, the centrifugal separator may be for separating liquid contaminants, such as oil, from gas. The gas may be crankcase gas of a combustion engine. However, the centrifugal separator may also be suitable for cleaning gases from other sources, for instance the environment of machine tools which frequently contains large amounts of liquid contaminants in the form of oil droplets or oil mist.

The stationary casing of the centrifugal separator comprises a surrounding side wall that surrounds the separation space. The surrounding sidewall may surround the separation space throughout the whole axial length of the separation space or throughout part of the axial length of the separation space. The stationary casing may further comprise first and second end walls, which enclose the separation space at its top and bottom. The stationary casing may have a cylindrical shape with circular cross-section having a radius R from the axis (X) of rotation to the surrounding side wall. This radius R may be constant at least with respect to a major part of the circumference of the surrounding side wall. The first and second end walls may thus form an upper end wall and a lower end wall of the cylindrical shaped casing. The stationary casing may also be slightly conical.

The gas inlet of the centrifugal separator may be arranged through the first end wall or through the surrounding side wall close to the first end wall, thus at the top of the separator, such that gas entering through the gas inlet is directed to the separation space. The downstream portion of the gas inlet may be centred around the axis of rotation (X). The gas inlet may further comprise an upstream portion in the form of an inlet conduit. The inlet conduit may be formed in a separate inlet module that is attached to the stationary casing. The inlet conduit may extend radially or axially from the centrifugal separator, or in any other direction therebetween.

The rotating member is arranged for rotation during operation by means of the drive member. The rotating member comprises a plurality of separation members arranged in the separation space. The separation members of the rotating member are examples of surface-enlarging inserts that promote separation of contaminants from the gas. The separation members may be a stack of separation discs.

Consequently, in embodiments of the first aspect, the plurality of separation members is a stack of separation discs, such as a stack of frustoconical separation discs. Such discs may have an outer radius and an inner radius, thus forming a central opening in the disc. The frustoconical separation discs may comprise a flat portion that extend perpendicularly to the axis of rotation (X), and a conical portion that extend outwardly and downwardly or upwardly from the flat portion. The flat portion may be closer to the rotational axis than the frustoconical portion.

Openings in the flat portion may form part of a central space within the centrifugal separator into which gas to be cleaned is guided from the gas inlet. Thus, gas to be cleaned may be guided into the central space and then to the interspaces formed between the discs in the disc stack. As a complement, or alternative, the central space may also be formed radially within the inner radius of the discs.

Further, the discs of the stack may be radial discs, in which substantially the whole disc extends in a plane that is perpendicular to the axis of rotation.

It is also to be understood that the separation members, such as separation discs, not necessarily have to be arranged in a stack. The separation space may for example comprise axial discs, or plates that extend around the axis of rotation. The axial discs or plates may be planar, i.e. extending in planes that are parallel to the axis of rotation. The axial discs or plates may also have a slightly or significantly curved shape, such as an arcuate or spiral shape, as seen in a radial plane.

In embodiments of the first aspect, the rotating member comprises an axial shaft that is supported by the at least one bearing. The axial shaft may thus be centred at the axis of rotation (X). The separation members may be arranged around such axial shaft.

The rotating member may be journaled within the stationary casing via at least one bearing, such as via an upper and lower bearing arranged axially above and below the stack of separation members, respectively.

The drainage outlet may be arranged in the lower portion of the stationary casing, such as arranged in the second end wall, e.g. at the bottom of the separator.

Separated contaminants may first be led from the separation space internally to e.g. a drive chamber in which the drive member is arranged. Such drainage from may be via internal drainage members formed by several spot shaped through holes of the stationary casing or by a single drainage passage. The drainage from the separation space may also be in an annular collection groove at the inner end wall of the stationary casing. The internal drainage may be arranged such that contaminants, such as oil, are drained though a bearing arranged for journaling the rotating member. If the drive member comprises a turbine wheel driven by an oil jet, the separated contaminants may be drained together with the oil used for driving the oil jet. Then, the drainage outlet of the centrifugal separator may be connected to the drive chamber.

Thus, the drainage outlet may be arranged axially at and end of the centrifugal separator that is opposite the end through which, or at which, the inlet is arranged. The drainage outlet may be arranged at the axis of rotation or centred around the axis of rotation.

The outlet for cleaned gas extends through a wall of the stationary casing, such as through a lower portion of the surrounding side wall of the stationary casing. The gas outlet may thus be a conduit for the clean gas having a gas inlet inside the stationary casing and a gas outlet outside of the stationary casing. Such conduit may extend through the stationary casing to a radial position that is larger than the radial position of outer wall of the stationary casing, or to a radial position that is the same as the radial position of the outer wall of the stationary casing. The gas outlet may be connected to a valve, such as a membrane valve, through which clean gas is transported before leaving the centrifugal separator.

During operation, gas to be cleaned may be directed centrally through the plurality of separation members, such as centrally through the stack of separation discs. In such a set-up, the rotating member may further define a central space formed by at least one through hole in the separation members. This central space is connected to the gas inlet and configured to convey the gas to be cleaned from the gas inlet to the interspaces between the separation members, such as between the interspaces between the discs of a stack of separation discs. A separation disc that may be used as separation member may comprise a central, essentially flat portion perpendicular to the axis of rotation. This portion may comprise the through holes that form part of the central space.

Thus, the centrifugal separator may be configured to convey gas to be cleaned, such as crankcase gases, from the gas inlet into a central portion of the rotating member. In this manner the crankcase gases may be “pumped” from the central portion of the rotating member into the interspaces between the separation discs in the stack of separation discs by the rotation of the rotating member. Thus, the centrifugal separator may work according to the concurrent flow principle, in which the gas flows in the disc stack from a radial inner part to a radial outer part, which is opposite to a separator operating according to the counter-current flow principle, in which the gas is conducted into the separation space at the periphery and conveyed towards a central part of the separation space.

The drive member may for example comprise a turbine wheel, rotated by means of an oil jet from the lubrication oil system of the combustion engine or a free jet wheel comprising a blow-back disk. However, the drive member may also be independent of the combustion engine and comprise an electrical motor, a hydraulic motor or a pneumatic motor.

The mounting bracket is used for fastening the centrifugal separator to an engine or engine block.

The first aspect of the invention is based on the insight that designing the mounting bracket to be fastened to the stationary casing and axially around the separation space, increases the vibrational stability and allows for using a mounting bracket of a less dense material. Further, buy having the mounting bracket and the stationary casing configured to allow permanently engaging the mounting bracket to the outer surface of the surrounding sidewall of the stationary casing in different angular positions, i.e. in a variety of angular positions, around the axis (X) of rotation increases the flexibility. In other words, the centrifugal separator may be adapted to a larger variety of different engine or engine blocks, since the design of the bracket and housing of the centrifugal separator allows for the relative position between the engine and e.g. the gas inlet, the gas outlet and the oil outlet of the separator to be varied simply by engaging the mounting bracket to the casing at different angular positions.

The mounting bracket being engaged with the outer surface of the surrounding sidewall of the stationary housing may be the mounting bracket being welded to or fastened by fastening means to the outer surface surrounding sidewall of the of the stationary housing.

The mounting bracket may be of a polymeric material, such as a plastic material. Alternatively, the mounting bracket may be of metal. The mounting bracket may be arranged for mounting the centrifugal separator firmly to e.g. a side surface of an engine or engine block.

The stationary casing may also be of a polymeric material, such as plastic.

In embodiments of the first aspect, the surrounding sidewall of the stationary casing has an overall curved shape, such as a circular shape, as seen in a radial plane.

In embodiments of the first aspect, the mounting bracket comprises at least a portion that conforms to the outer surface of the surrounding sidewall of the stationary casing.

The at least one portion may thus form an engagement surface engaging with the outer surface surrounding sidewall of the of the stationary casing. As an example, the at least one portion may engage with ribs of the outer surface of the stationary casing, said ribs extending in the circumferential direction. The at least one portion may be welded to the outer surface surrounding sidewall of the of the stationary casing, as will be discussed below. The at least one portion may be of a polymeric material, such as a plastic.

As an example, the mounting bracket may conform to the outer surface of the surrounding sidewall of the stationary casing along at least 25% of the circumference of the surrounding sidewall of the stationary casing.

Thus, the mounting bracket may “enclose” a portion of the circumference of the surrounding sidewall of the stationary casing that is at least 25%. This may increase the engagement strength to the stationary casing. As a further example, mounting bracket may conform to the outer surface of the surrounding sidewall of the stationary casing along at least 35%, such as along at least 40% of the circumference of the surrounding sidewall of the stationary casing.

In embodiments of the first aspect, the outer surface of the surrounding sidewall of the stationary casing extends a distance A1 in the axial direction, and the mounting bracket is engaged with the outer surface of the surrounding sidewall of the stationary casing at least along a distance that is 0.5 A1.

Consequently, the mounting bracket may be engaged to the surrounding sidewall of the stationary casing an axial distance that is at least half of the axial distance of the whole surrounding sidewall of the stationary casing. The axial distance of the stationary casing is thus the axial distance of the stationary portion used to delimit the separation space enclosed therein, and not including e.g. the axial distance of any stationary drive module attached to the casing.

As an example, the mounting bracket may be engaged with the outer surface of the surrounding sidewall of the stationary casing at least along a distance that is 0.7 A1, such as at least 0.9 A1. Thus, the mounting bracket may cover more or less the whole axial distance of the surrounding sidewall of the stationary casing.

In embodiments of the first aspect, the stationary casing comprises a polymeric material that is welded to the mounting bracket, thereby permanently engaging the mounting bracket with the outer surface surrounding sidewall of the of the stationary casing.

The inventors have found that using welding for engaging the mounting bracket to the outer surface surrounding sidewall of the of the stationary casing is advantageous in that it allows for engaging the mounting bracket to the outer surface surrounding sidewall of the of the stationary casing in different angular positions around the axis (X) of rotation. Further, using welding decreases the need for using other attachment means, such as screws, between the stationary casing and the mounting bracket.

Consequently, in embodiments, the engagement between the mounting bracket and the stationary casing is free of any other fastening means than the weld, such as free of any screw members.

Any type of welding may be used for engaging the mounting bracket and the stationary casing. The weld formed between the mounting bracket and the stationary casing may be weld formed by infrared (IR)-welding. The inventors have found that IR-welding is very advantageous for engaging the mounting bracket and the stationary housing, as will be discussed in relation to the second aspect of the invention below.

The formed weld may extend along at least 25% of the circumference of the stationary casing.

The stationary casing may comprise ribs, such as circumferential ribs, of a polymeric material that forms part of the weld between the mounting bracket and the stationary casing.

As an example, the mounting bracket may be of a polymeric material that is welded to the polymeric material of the stationary casing. Hence, a major part of the mounting bracket may be of a polymeric material. This may decrease the overall weight of the centrifugal separator. Thus, due to using welding, the inventors have realised that the carrying structure of the centrifugal separator, i.e. the mounting bracket, may be of polymeric material but still give enough strength and support to the separator.

As an alternative, the mounting bracket may be of metal but comprise at least one polymeric member which is welded to the polymeric material of the stationary casing. Such polymeric member may for example be in the form of strips of polymeric material. Such polymeric strips may be arranged in the circumferential direction of the stationary casing and may be welded e.g. to circumferentially extending ribs on the outer surface of the surrounding sidewall of the stationary casing.

In embodiments of the first aspect, the drive member is arranged in a separate drive chamber within a drive module. Such drive module may be arranged axially above or below the stationary casing.

The drive module may for example be a drive module forming a drive chamber in which the drive member, e.g. in the form of an electrical motor a turbine wheel, is arranged. The drive module may thus be a stand-alone part that can be removed from the stationary casing.

As an example, the drive module may be welded onto the stationary casing.

The drive module may thus comprise an outer surface having a portion of a polymeric material that is welded to a polymeric portion of the stationary casing, e.g. by using infrared (IR)-welding. As an example, the outer surface of the drive module may be of a polymeric material. It thus also follows that the weld formed between the stationary casing and the drive module may be an IR weld.

Furthermore, as discussed above, the gas inlet may comprise an inlet conduit that is arranged in an inlet module, i.e. a module that is separate from the stationary casing. As with the drive module, also the inlet module may be welded to an outer surface of the stationary casing. Consequently, also the inlet module may comprise an outer surface having a portion of a polymeric material that is welded to a polymeric portion of the stationary casing, e.g. by using infrared (IR)-welding. As an example, the outer surface of the inlet module may be of a polymeric material. It thus also follows that the weld formed between the stationary casing and the inlet module may be an IR weld.

As an example, the inlet module may be welded to a first end of the stationary casing and the drive module may be welded to a second end, opposite the first end of the stationary casing.

In embodiments of the first aspect, the mounting bracket comprises mounting points for mounting the mounting bracket onto an engine or an engine block, and wherein the mounting points are arranged at different axial positions.

In embodiments of the first aspect, the mounting bracket comprises mounting points for mounting the mounting bracket onto an engine or an engine block, and wherein the mounting points are distributed so that there is at least one mounting point axially on each side of the centre of gravity (CG) of the centrifugal separator.

The mounting points may be through holes for receiving a fastening means, such as a screw, such that the mounting bracket, and thus the whole centrifugal separator, may be fastened to an engine or engine block.

The inventors have found that having the mounting points on each axial side of the centre of gravity of the centrifugal separator makes the whole construction more stable and less sensitive to vibrations when fastened to an engine or engine block. Further, it facilitates using a mounting bracket that is not of metal but instead of a less dense material, which thus decreases the overall weight of the centrifugal separator. Hence, having mounting points on each axial side of the centre of gravity facilitates the use of a mounting bracket of a polymeric material that may be welded to the stationary casing, as discussed above.

As an example, there may be at least two mounting points axially on each axial side of the centre of gravity (CG) of the centrifugal separator.

The at least two mounting point may in addition be distributed so that is at least one mounting point on each side of the axis of rotation (X).

However, in case of e.g. a very heavy electrical motor, the centre of gravity may be shifted a rather large distance in the axial direction and the mounting points may then be distributed all on one axial side of the centre of gravity of the whole centrifugal separator. Thus, in embodiments of the first aspect, the mounting bracket comprises mounting points for mounting the mounting bracket onto an engine or an engine block, and wherein the mounting points are distributed so that there is at least one mounting point axially on each side of the centre of gravity (CG) of the centrifugal separator excluding the drive member, such as an electrical motor.

As a second aspect of the invention, there is provided a method for assembling a centrifugal separator for cleaning gas, comprising the steps of
a) providing a stationary casing enclosing a separation space through which a gas flow is permitted;
b) providing a mounting bracket configured for mounting the centrifugal separator onto an engine or an engine block; and
c) welding the stationary casing and the mounting bracket together using infrared (IR) welding.

This aspect may generally present the same or corresponding advantages as the former aspects. Effects and features of the second aspect are largely analogous to those described above in connection with the first aspect. Embodiments mentioned in relation to the first aspect are largely compatible with the third aspect.

IR welding is a welding technique that utilizes non-contact heating o melt and fuse polymeric, such as thermoplastic, parts together using the energy from infrared radiation.

The inventors have found that infrared welding (IR) welding is particularly advantageous when joining a stationary casing and a mounting bracket together.

This is due to the insight that plenty of energy may be needed when melting e.g. the polymeric material over the large contact area needed for forming the strong weld between the mounting bracket and the stationary casing. It has been found that it is vital for the structural stiffness-to get a high resonance frequency-to have a large contact area. For this reason, other techniques such as sonic welding or laser welding may not be suitable. Moreover, it has been found that IR welding do not cause vibrations like vibration welding, which may damage ball bearings used in centrifugal separators. Further, due to the contact free IR welding, less maintenance is needed as compared to hot plate welding.

The part of the stationary casing and the part of the mounting bracket forming the weld may be polymeric parts, such as thermoplastic parts.

Thus, in embodiments of the second aspect, the IR welding of step c) is between a polymeric portion of said stationary casing and a polymeric portion of said mounting bracket.

The outer surface of the surrounding sidewall of the stationary casing may extend a distance A1 in the axial direction and step c) may comprise welding the stationary casing and the mounting bracket together such that the mounting bracket is welded to the outer surface of the surrounding sidewall of the stationary casing at least along a distance that is 0.5 A1, such as at least 0.7 A1, such as at least 0.9 A1.

As a further example, step c) may be performed so the mounting bracket conforms to the outer surface of the surrounding sidewall of the stationary casing along at least 25% of the circumference (c1) of the stationary casing, such as along at least 35%, such as along at least 40%, of the circumference of the stationary casing.

Not only the mounting bracket may be welded to the stationary casing. In embodiments of the second aspect, the method further comprises the steps of
d) providing a drive module enclosing a drive chamber that comprises a drive member for rotating a rotating member in said separation space of the stationary casing; and
e) welding said drive module and said stationary casing together.

As an example, step e) may comprise welding the drive module to an axial end, such as to the axial lower end, of the stationary casing.

The welding of step e) may be laser welding. Laser welding may give a seal with better sealing functions compared to e.g. IR welding, which is relevant for sealing of the drive module.

In a further example, the method comprises the steps of
f) providing an inlet module comprising an inlet conduit for gas to be cleaned by the centrifugal separator; and
g) welding said inlet module and said stationary casing together.

The welding used in step g) may be IR-welding or laser welding.

As an example, step g) may comprise welding the inlet module to an axial end, such as to the axial upper end, of the stationary casing.

If both a drive module and an inlet module is welded to the stationary casing, then the drive module may be welded to a first end and the inlet module to a second end, opposite the first end, of the stationary casing.

Steps f) and g) may be performed after steps d) and e). However, in embodiments of the second aspect, steps f) and g) are performed before steps d) and e), i.e. the inlet module is welded to the stationary casing before welding the drive module to the stationary casing.

In embodiments of the second aspect, the centrifugal separator being assembled is a centrifugal separator according to any example or embodiment of the first aspect discussed herein.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of the cross-section of an embodiment of a centrifugal separator for cleaning gas.

FIG. 2 shows a perspective view of a mounting bracket.

FIGS. 3a and 3b shows a perspective view and a section view, respectively, of how the mounting bracket and the stationary casing may be engaged in different angular positions around the axis (X) of rotation.

FIG. 4 shows a perspective view of an embodiment of a centrifugal separator.

FIG. 5 shows a perspective view of an embodiment of a centrifugal separator.

### DETAILED DESCRIPTION

The centrifugal separator according to the present disclosure will be further illustrated by the following description with reference to the accompanying drawings.

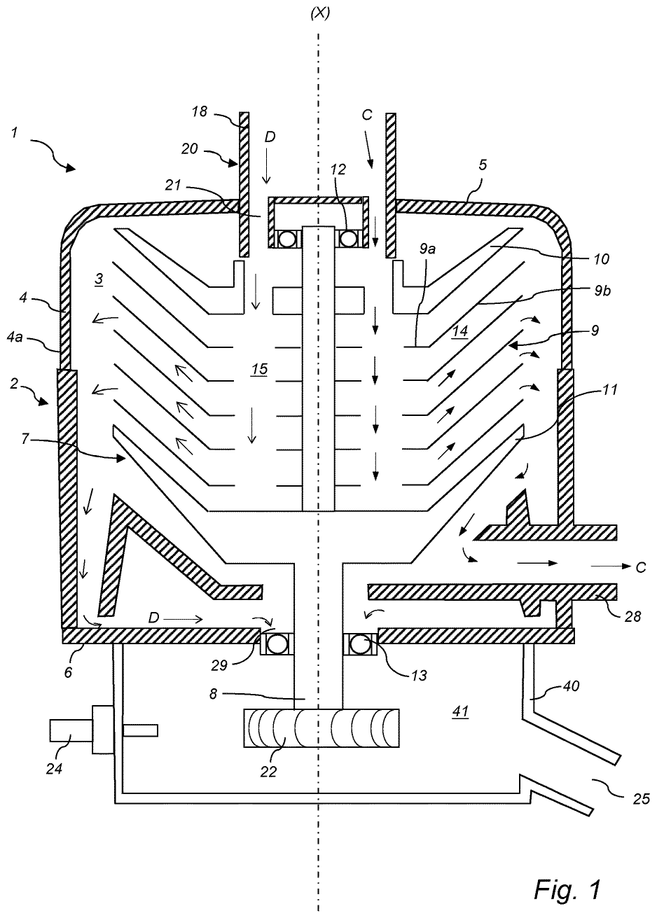

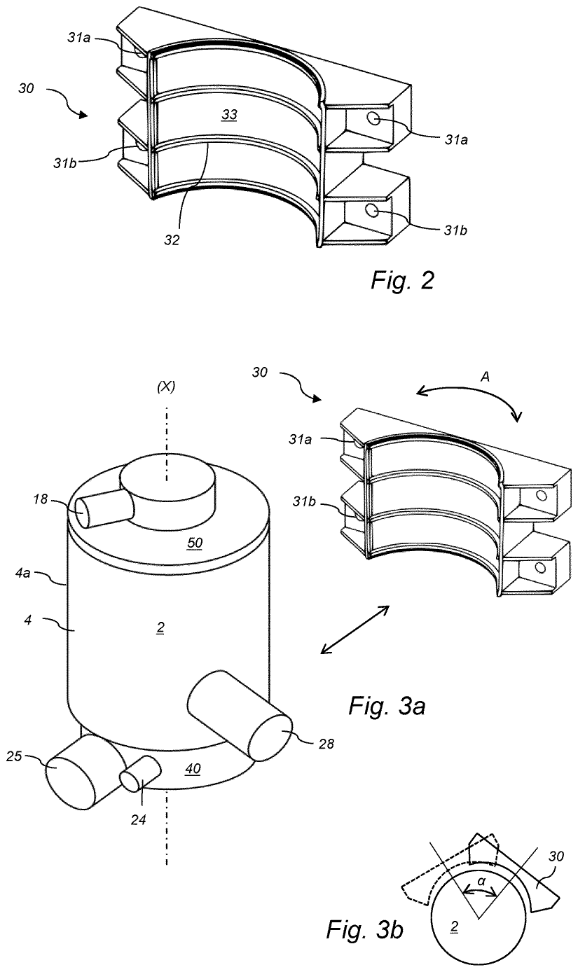

FIG. 1 shows a cross-section of a centrifugal separator 1 according to the present disclosure. The centrifugal separator 1 is configured to be mounted to a combustion engine (not disclosed), especially a diesel engine, at a suitable position, such as on top of the combustion engine or at the side of the combustion engine via a mounting bracket 30 (see FIGS. 2-5). Tt is to be noted that the centrifugal separator 1 is also suitable for cleaning gases from other sources than combustion engines, for instance the environment of machine tools which frequently contains large amounts of liquid contaminants in the form of oil droplets or oil mist.

The stationary casing 2 of the centrifugal separator 1 encloses a separation space 3 through which a gas flow is permitted. The stationary casing 2 comprises, or is formed by, a surrounding side wall 4, an upper end wall 5 and a lower end wall 6. The surrounding sidewall 4 forms outer surface 4a of the stationary casing 2. The surrounding sidewall 4 surrounds the separation space 3 at least throughout a part of the axial length of the separation space 3.

The centrifugal separator 1 further comprises a rotating member 7, which is arranged to rotate around an axis (X) of rotation. It should be noted that the stationary casing 2 is stationary in relation to the rotating member 7, and preferably in relation to the combustion engine to which it may be mounted.

The stationary casing 2 has a radius from the axis (X) of rotation to the surrounding side wall 4 that is constant at least with respect to a major part of the circumference of the surrounding side wall 4. The surrounding side wall 4 thus has a circular, or substantially, circular cross-section in a radial plane.

The rotating member 7 comprises a rotatable shaft, i.e. spindle 8 and a stack of separation discs 9 attached to the spindle 8. All the separation discs of the stack 9 are provided between a top disc 10 and a lower end plate 11.

The spindle 8, and thus the rotating member 7, is rotatably supported in the stationary casing 2 by means of an upper bearing 12 and a lower bearing 13, the bearings being arranged one on each axial side of the stack of separation discs 9. However, the bearings could for example both be arranged axially below or above the stack 9 of separation discs.

The separation discs of the disc stack 9 are frusto-conical and extend outwardly and upwardly from the spindle 8. The separation discs thus comprise a flat portion 9a, which extend perpendicularly to the axis of rotation (X), and a conical portion 9b, that extend outwardly and upwardly from the flat portion 9a. It should be noted that the separation discs also could extend outwardly and downwardly, or even radially.

The separation discs of the stack 9 are provided at a distance from each other by means of distance members (not disclosed) in order to form interspaces 14 between adjacent separation discs, i.e. an interspace 14 between each pair of adjacent separation discs. The axial thickness of each interspace 14 may e.g. be in the order of 0.5-2 mm, such as 1-2 mm.

The separation discs of the stack 9 may be made of plastic or metal. The number of separation discs in the stack 9 is normally higher than indicated in FIG. 1 and may be for instance 50 to 100 separation discs depending on the size of the centrifugal separator 1.

The centrifugal separator 1 comprises an oil nozzle 24 arranged for being connected to an engine oil circuit of an internal combustion engine. During running of the internal combustion engine, oil is pumped through the oil nozzle 24 onto a drive member in form of turbine wheel 22, which is arranged in a drive chamber 41 in drive module 40. The drive chamber 41 and drive module thus forms a turbine housing. Since turbine wheel 22 is connected to the spindle 8, the rotating member 7, and thus the stack of separation discs 9, also rotate upon rotation of wheel 22. As an alternative, the centrifugal separator 1 may comprise an electric motor arranged to rotate the spindle 8 and rotating member 7. As a further alternative, the centrifugal separator 3 may comprise a turbine wheel connected to the spindle 8, where the turbine wheel is arranged to be driven by exhaust gases from the internal combustion engine to rotate the spindle 8 and the rotating member 7. The rotating member 7 may also be arranged for being rotated by a mechanical drive unit. Thus, the centrifugal separator may comprise a mechanical drive unit for rotating the rotating member.

The rotating member 7 defines a central space 15. The central space 15 is formed by a through hole in each of the separation discs 9. In the embodiments of FIG. 1, the central space 15 is formed by a plurality of through holes, each extending through the top disc 10 and through each of the separation discs 9, but not through the lower end plate 11. The through holes are arranged in the flat portions 9a of the separation discs.

The gas inlet 20 is for the supply of the gas to be cleaned. The gas inlet 20 extends through the stationary casing 2, and more precisely through upper end wall 5. The gas inlet 20 is formed by the axially extending inlet conduit 18, which forms an upstream portion, and by through channels 21 that form a downstream portion of the inlet 20.

The through channels 21 are in fluid connection with central space 15 and are arranged radially outside the upper bearing 12. Thus, the gas inlet 20 communicates with the central space 15 so that the gas to be cleaned is conveyed from the inlet 20 via the central space 15 to the interspaces 14 of the stack of separation discs 9. The gas inlet 20 is configured to communicate with the crankcase of the combustion engine, or any other source, via the inlet conduit 18 permitting the supply of crankcase gas from the crankcase to the gas inlet 20 and further to the central space 15 and the interspaces 14 as explained above.

The stationary casing 2 comprises internal outlet 29 arranged in the lower portion of the stationary casing 2 and configured to permit discharge of liquid contaminants separated from the gas from the stationary casing 2 to the drive module 40. The internal outlet 29 is in this embodiment in the form of through holes arranged in the lower end wall 6 so that separated liquid contaminants flow through the lower bearing 13 as they are drained from the separation space 3 to the drive chamber 41. The separated oil, and other particles and/or substances, is led to the drainage outlet 25 of the centrifugal separator 1, which together with oil from the oil nozzle 24 used to drive the wheel 22 may be led back to the engine oil circuit of an internal combustion engine.

The gas outlet 28 of the centrifugal separator 1 is arranged through the stationary casing 2 and is configured to permit discharge of cleaned gas.

During operation of the centrifugal separator as shown in FIG. 1, the rotating member 7 is kept in rotation by the oil nozzle 24 supplying oil against the wheel 22. As an example, the rotational speed may be in the range of 7.500-12.000 rpm. Contaminated gas, e.g. crankcase gas from the crankcase of an internal combustion engine, is supplied to the gas inlet 20 via conduit 18. This gas is conducted further into the central space 15 and from there into and through the interspaces 14 between the separation discs of the stack 9. As a consequence of the rotation of the rotating member 7 the gas is brought to rotate, whereby it is pumped further on radially outwardly through gaps or interspaces 14.

During the rotation of the gas in the interspaces 14, solid or liquid particles such as oil suspended in the gas are separated therefrom. The particles settle on the insides of the conical portions 9b of the separation discs and slide or run after that radially outwardly thereon. When the particles and/or liquid drops have reached out to the radial outer edges of the separation discs 9, they are thrown away from the rotating member 7 and hit the inner surface of the surrounding side wall 4. Separated oil particles may form a film on the inner surface of the stationary casing 2. From there, oil may be pulled by gravity downwardly to bottom end wall 6 and then and leave the separation space 3 through the internal outlet 29. For this, the inner wall of the bottom end wall 6 may be tilted radially inwards, so that oil leaving the surrounding inner wall of the stationary casing 2 may be pulled by gravity towards internal outlet 29. The path of the contaminants in the gas is schematically illustrated by arrows “D” in FIG. 1.

Cleaned gas freed from particles and exiting from the stack of separation discs 9 leaves the stationary casing 2 through the gas outlet 28. The path of the gas through the centrifugal separator 1 is schematically shown by arrows “C” in FIG. 1.

FIG. 2 shows a perspective view of a separate mounting bracket 30 used for mounting the centrifugal separator onto an engine or an engine block. The mounting bracket may be permanently engaged to the outer surface 4a of the surrounding sidewall 4 of the stationary casing 2, e.g. by means of welding. The mounting bracket comprises an inner curved surface 33 with the same overall curvature as the outer surface 4a of the surrounding sidewall 4 of the stationary casing 2. This inner curved surface is a concave surface that comprises a plurality of horizontal ridges or stripes 32, that upon engagement with the outer surface 4a of the surrounding sidewall 4 of the stationary casing 2 conforms to that outer surface. Thus, weld lines between the mounting bracket 30 and the stationary casing 2 may be formed along the horizontal ridges or stripes 2 for permanently engaging the mounting bracket 30 with the outer surface 4a of the stationary casing.

The mounting bracket may be a single piece, such as a single piece of a polymeric material. This enables IR welding of the mounting bracket 30 to a polymeric portion of the outer surface 4a of the surrounding sidewall 4 of the stationary casing 2. As an alternative, the mounting bracket 30 may be of a different material, such as a metal, whereas the horizontal ridges or stripes 32 are of a polymeric material that may be welded to the outer surface 4a surrounding sidewall 4 of the of the stationary casing 2.

Also shown in FIG. 2 are a plurality of mounting points, in this case upper mounting points 31a and lower mounting points 31b, that may be used for fastening the bracket, and thus the whole centrifugal separator 1 if the mounting bracket is permanently engaged with the stationary casing 2, to an engine or engine block. The mounting points 31a, 31b, are in this example through holes arranged for receiving some fastening means, such as a screw.

FIGS. 3a and 3b illustrate that the mounting bracket 30 and the stationary casing 2 are configured to allow permanently engaging the mounting bracket 30 to the outer surface 4a surrounding sidewall 4 of the of the stationary casing 2 in a variety of angular positions around the axis (X) of rotation. As indicated by arrow “A” in FIG. 3a, the mounting bracket 30 may be rotated around rotational axis (X) in a variety of angular positions but still fit to the outer surface 4a surrounding sidewall 4 of the of the stationary casing 4. This is also illustrated in FIG. 3b, which shows a section in the radial plane of the stationary housing 2 and the mounting bracket 30. By rotating the mounting bracket 30 around rotational axis (X), as indicated by rotational angle α, the mounting bracket 30 may be engaged to the stationary casing 2 in a variety of positions. This is thus due to the configuration of the outer surface 4a surrounding sidewall 4 of the of the stationary casing and the mounting bracket 30, especially the inner concave surface 33.

An angular position around the rotational axis (X) is thus the angular position as seen in the radial plane, and rotation from a first to a second angular position around rotational axis (X) forms a rotational angle α in the radial plane. The rotational angle α is thus the angle in the radial plane between an imaginary straight line from the rotational axis (X) to the mounting bracket before rotation and the imaginary straight line from the rotational axis (x) to the mounting bracket after rotation, as illustrated in FIG. 3b.

It should be noted that the stationary casing 2 is schematically illustrated in FIG. 3a. Also shown is a drive module 30 and an inlet module 50 attached to the stationary casing. In this example, the drive module is welded to the stationary casing to fit to the lower end portion of the stationary casing 2, whereas the inlet module 50 is welded to the stationary casing 2 fit to the upper end portion of the stationary casing 2. The drive module 40 comprises the drainage outlet 25 and the inlet to the oil nozzle 24 and the inlet module comprises inlet conduit 18, all extending in a direction out from the stationary casing 2. Also stationary casing 2 comprises gas outlet 28 extending out from the surface of the stationary casing. Thus, by the configuration of the mounting bracket 30, the position of the drainage outlet 25, the inlet conduit 18 and the gas outlet 28 in relation to the engine or engine block may be varied simply by varying the position of the mounting bracket around the axis of rotation (X) before permanently engaging the mounting bracket and the stationary casing, e.g. by welding.

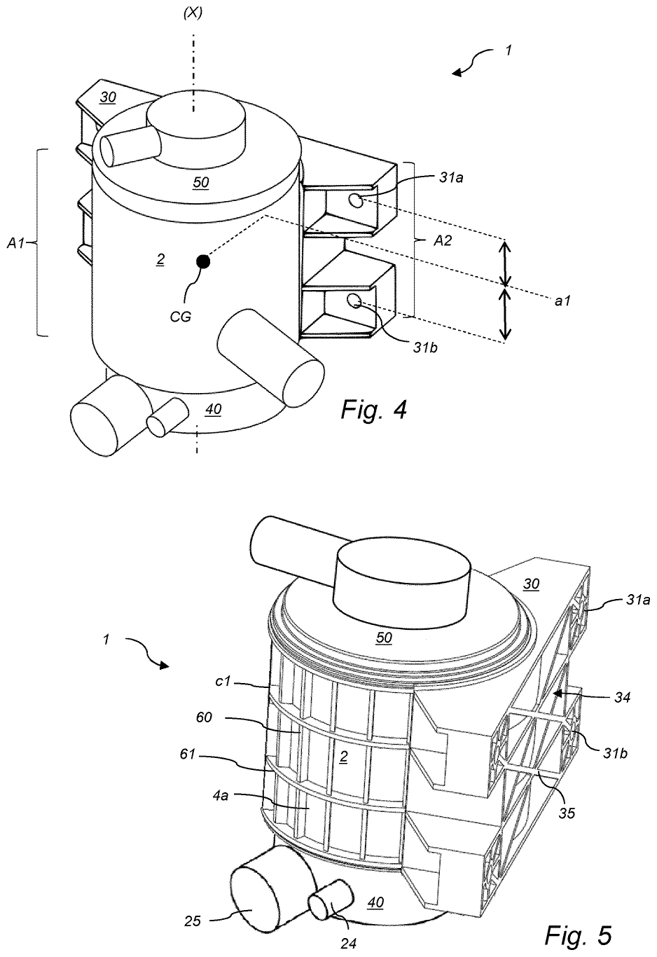

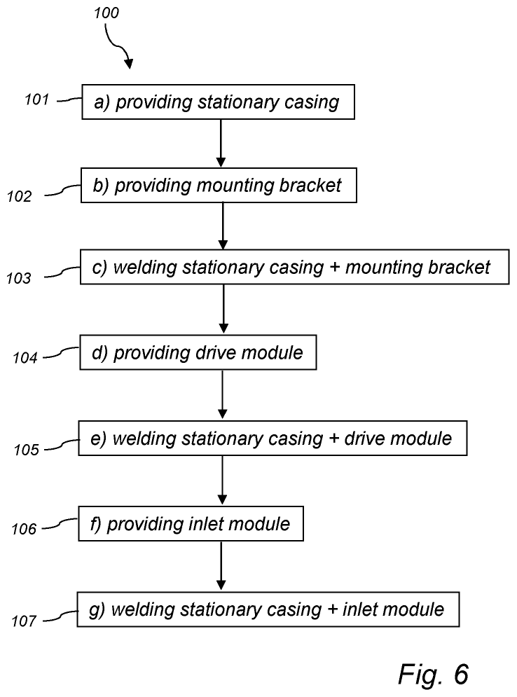

FIG. 4 shows a schematic perspective view of the whole centrifugal separator 1 when the mounting bracket 30 has been permanently engaged to the outer surface of the surrounding sidewall 4 of the 4a of the stationary casing. When permanently engaged, the mounting bracket 30 conforms the outer surface 4a of the stationary casing 2 along the circumference c1 of the stationary casing (see FIG. 5), such as along at least 25% of the circumference c1 of the stationary casing 2. As shown in FIG. 4, the mounting bracket 30 may conform to between 25-50% of the circumference c1 of the stationary casing 2. If welded to the stationary casing 2, the welding line may form the part in which the mounting bracket 30 conforms to the outer surface of the stationary casing 2.

Moreover, as illustrated in FIG. 4, the outer surface 4a of the surrounding sidewall 4 of the stationary casing 2 extends a distance A1 in the axial direction, and the mounting bracket 30 encloses or is engaged with the outer surface 4a of the surrounding sidewall 4 of the stationary casing 2 at least along a distance A2 that is 0.5 A1, such as between 0.5 A1 to 1.0 A1.

Also, the mounting points 31a, 31b for mounting the mounting bracket 30 onto an engine or an engine block, are distributed so that there is at least one mounting point 31a, 31b axially on each side of the centre of gravity (CG) of the centrifugal separator 1. Thus, the centre of gravity of the centrifugal separator is located at axial position a1, and the two upper mounting points 31a are located axially above a2 whereas the two lower mounting points 31b are located axially below a1. Further, the mounting points 31a, 31b are distributed so that there is at least two mounting points 31a, 31b on each side of the axis of rotation (X).

The drive member is in this example arranged in a separate drive module 40 that is welded to the axially lower portion of the stationary casing 2. As an example, the drive module may be welded using laser welding to the bottom end wall of the stationary casing. The drive module 40 is thus a stand-alone part comprising e.g. an electrical motor or a turbine wheel, which may be welded to e.g. the upper or lower portion of the stationary casing 2. The drive member is thus arranged in a separate drive chamber within the drive module 40.

The stationary inlet conduit is in this example comprised in the inlet module 50 that is welded to the upper portion, such as to the upper end wall, of the stationary casing 2. Thus, all of the mounting bracket 30, the drive module 40 and the inlet module 50 may be welded to the stationary casing 2.

However, in embodiments, both the drive module 40 and the inlet module 50 may be arranged axially on the same side of the stationary casing 2 such as both being arranged axially above the stationary casing 2.

In the perspective view of the centrifugal separator of FIG. 5, also the backside 34. of the mounting bracket 30 is shown, i.e. the side not facing the stationary casing 2. The mounting bracket 2 is comprises ribs 35 on the backside 3 to reduce the overall weight of the mounting bracket 30. The ribs all end in an imaginary axial plane of the backside to allow a tight engagement with an engine or engine block.

Further, as illustrated in FIG. 5, the outer surface 4a of the surrounding sidewall 4 of the stationary casing 2 comprises circumferentially extending ribs 61. These ribs 61 and the ribs 32 of the inner concave surface 30 of the mounting bracket 30, are welded together to presently engage the mounting bracket to the stationary casing 2. Thus, the weld is formed from melting circumferential ribs 61 of the stationary casing 2 and the ribs 32 of the mounting bracket 30. Further, there are axially extending ribs 60 on the outer surface 4a surrounding sidewall 4 of the of the stationary casing 2 that increases the strength of the stationary casing 2.

FIG. 6 illustrates the steps of a method 100 for assembling a centrifugal separator 1 for cleaning gas, such as the centrifugal separator 1 discussed in relation to of FIGS. 1-5 above.

The method comprises the step a) of providing 101 a stationary casing 2 enclosing a separation space 3 through which a gas flow is permitted and a step b) of providing 102 a mounting bracket 30 configured for mounting the centrifugal separator 1 onto an engine or an engine block. The method 100 further comprises the step c) of welding 103 the stationary casing (2) and the mounting bracket (30) together using infrared (IR) welding.

As an example, the IR welding of step c) may be between a polymeric portion of stationary casing 2 and a polymeric portion of said mounting bracket 30, such as between ribs 61 in FIG. 5 and ribs 32 of FIG. 2

The method 100 may further comprise the step d) of providing 104 a drive module 40 enclosing a drive chamber 41 that comprises a drive member 22 for rotating a rotating member 7 in the separation space 3 of the stationary casing 2, and a step e) of welding 105 the drive module 40 and the stationary casing 2 together. Step e) may be performed using laser welding.

Moreover, the method 100 may comprise also welding an inlet module 50 to the stationary casing 2. Thus, the method 100 may comprise the step f) of providing 106 an inlet module 50 comprising an inlet conduit 18 for gas to be cleaned by the centrifugal separator 1 and a step g) of welding 107 the inlet module to the stationary casing.

The drive module 40 and the inlet module 50 may be attached to the same axial end of the stationary casing 2. Thus, the weld formed in step e) may be welding the drive module 40 directly to the stationary casing 2 or indirectly to the stationary casing 2, such as welding the drive module 40 to another module that has already been attached to the stationary casing, such as to an inlet module 50.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A centrifugal separator for cleaning gas containing contaminants, said centrifugal separator comprising:
a stationary casing, enclosing a separation space through which a gas flow is permitted and comprising a surrounding sidewall that surrounds said separation space;
a gas inlet extending through the stationary casing and permitting supply of the gas to be cleaned;
a rotating member comprising a plurality of separation members arranged in said separation space and being arranged to rotate around an axis of rotation;
a gas outlet configured to permit discharge of cleaned gas out from the stationary casing;
a drainage outlet configured to permit discharge from the centrifugal separator of liquid contaminants that have been separated from the gas; and
a drive member for rotating the rotating member,
wherein the centrifugal separator further comprises:
a mounting bracket configured for mounting the centrifugal separator onto an engine or an engine block and engaged with the outer surface of the surrounding sidewall of the stationary casing, and
wherein the mounting bracket and the stationary casing are configured to allow permanently engaging the mounting bracket to the outer surface of the surrounding sidewall of the stationary casing in different angular positions around the axis of rotation.

2. The centrifugal separator according to claim 1, wherein the mounting bracket comprises at least a portion that conforms to the outer surface of the surrounding sidewall of the stationary casing.

3. The centrifugal separator according to claim 2, wherein the mounting bracket conforms to the outer surface of the surrounding sidewall of the stationary casing along at least 25% of the circumference of the surrounding sidewall of the stationary casing.

4. The centrifugal separator according to claim 1, wherein the outer surface surrounding sidewall of the of the stationary casing extends a distance A1 in the axial direction, and wherein the mounting bracket is engaged with the outer surface surrounding sidewall of the of the stationary casing at least along a distance that is 0.5 A1.

5. The centrifugal separator according to claim 1, wherein the stationary casing comprises a polymeric material that is welded to the mounting bracket, thereby permanently engaging the mounting bracket with the outer surface surrounding sidewall 4 of the of the stationary casing.

6. The centrifugal separator according to claim 5, wherein the mounting bracket is of a polymeric material that is welded to the polymeric material of the stationary casing.

7. The centrifugal separator according to claim 5, wherein the mounting bracket is of metal but comprises at least one polymeric member which is welded to the polymeric material of the stationary casing.

8. The centrifugal separator according to claim 1, wherein the drive member is arranged in a separate drive chamber within a drive module, said drive module being arranged axially above or below the stationary casing.

9. The centrifugal separator according to claim 8, wherein the drive module is welded onto the stationary casing.

10. The centrifugal separator according to claim 1, wherein the mounting bracket comprises mounting points for mounting the mounting bracket onto an engine or an engine block, and
wherein the mounting points are distributed so that there is at least one mounting point axially on each side of the centre of gravity of the centrifugal separator.

11. The centrifugal separator according to claim 10, wherein there is at least two mounting points axially on each side of the centre of gravity of the centrifugal separator..

12. A method for assembling a centrifugal separator for cleaning gas, comprising the steps of
a) providing a stationary casing enclosing a separation space through which a gas flow is permitted;
b) providing a mounting bracket configured for mounting the centrifugal separator onto an engine or an engine block; and
c) welding the stationary casing and the mounting bracket together using infrared welding.

13. The method according to claim 12, wherein the IR welding of step c) is between a polymeric portion of said stationary casing and a polymeric portion of said mounting bracket.

14. The method according to claim 12, wherein the method further comprises the steps of
d) providing a drive module enclosing a drive chamber that comprises a drive member for rotating a rotating member in said separation space of the stationary casing; and
e) welding said drive module and said stationary casing together.

15. The method according to claim 12, wherein the stationary casing includes a surrounding sidewall that surrounds said separation space,
wherein the centrifugal separator further comprises:
a gas inlet extending through the stationary casing and permitting supply of the gas to be cleaned;
a rotating member comprising a plurality of separation members arranged in said separation space and being arranged to rotate around an axis of rotation;
a gas outlet configured to permit discharge of cleaned gas out from the stationary casing;
a drainage outlet configured to permit discharge from the centrifugal separator of liquid contaminants that have been separated from the gas; and
a drive member for rotating the rotating member,
wherein the mounting bracket is engaged with the outer surface of the surrounding sidewall of the stationary casing, and
wherein the mounting bracket and the stationary casing are configured to allow permanently engaging the mounting bracket to the outer surface of the surrounding sidewall of the stationary casing in different angular positions around the axis of rotation.

16. The centrifugal separator according to claim 2, wherein the outer surface surrounding sidewall of the of the stationary casing extends a distance Al in the axial direction, and
wherein the mounting bracket is engaged with the outer surface surrounding sidewall of the of the stationary casing at least along a distance that is 0.5 A1.

17. The centrifugal separator according to claim 3, wherein the outer surface surrounding sidewall of the of the stationary casing extends a distance Al in the axial direction, and
wherein the mounting bracket is engaged with the outer surface surrounding sidewall of the of the stationary casing at least along a distance that is 0.5 A1.

18. The centrifugal separator according to claim 2, wherein the stationary casing comprises a polymeric material that is welded to the mounting bracket, thereby permanently engaging the mounting bracket with the outer surface surrounding sidewall 4 of the of the stationary casing.

19. The centrifugal separator according to claim 3, wherein the stationary casing comprises a polymeric material that is welded to the mounting bracket, thereby permanently engaging the mounting bracket with the outer surface surrounding sidewall 4 of the of the stationary casing.

20. The centrifugal separator according to claim 4, wherein the stationary casing comprises a polymeric material that is welded to the mounting bracket, thereby permanently engaging the mounting bracket with the outer surface surrounding sidewall 4 of the of the stationary casing.
